(19) United States
(12) Patent Application Publication
(10) Pub. No.: US 2009/0113551 A1
(43) Pub. Date: Apr. 30, 2009

(54) DEVICE AND METHOD FOR INSPECTING NETWORK EQUIPMENT FOR VULNERABILITIES USING SEARCH ENGINE

(76) Inventors: Jong Moon LEE, Daejeon (KR); Jung Gil PARK, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/056,894

(22) Filed: Mar. 27, 2008

(30) Foreign Application Priority Data
Oct. 24, 2007 (KR) 10-2007-0107030

(51) Int. Cl. G06F 11/00

(52) U.S. Cl. 726/25

(57) ABSTRACT

Provided is a device and method for inspecting network equipment for vulnerabilities using a search engine from a remote location. The device for inspecting network equipment for vulnerabilities includes: a network structure examination module for examining the structure of a system network and generating network structure information; a control module for selecting at least one subnet for vulnerability inspection according to the network structure information; a vulnerable network equipment examination module for examining at least one piece of target network equipment for vulnerability inspection in the at least one selected subnet using a search engine; a vulnerability inspection module for inspecting the target network equipment for vulnerabilities; and an inspection result display module for outputting inspection results received from the vulnerability inspection module. The time taken to perform a vulnerability inspection and the overhead of a system subject to inspection may be reduced by selecting one of the system's subnets for inspection according to network structure information, examining the selected subnet for potentially vulnerable network equipment using a search engine, and inspecting only potentially vulnerable network equipment for vulnerabilities.

### CROSS-REFERENCE TO RELATED APPLICATION

This application claims priority to and the benefit of Korean Patent Application No. 2007-107030, filed Oct. 24, 2007, the disclosure of which is incorporated herein by reference in its entirety.

### BACKGROUND

1. Field of the Invention

The present invention relates to a device and method for inspecting network equipment for vulnerabilities, and more particularly, to a device and method for inspecting network equipment for vulnerabilities using a search engine from a remote location.

2. Discussion of Related Art

Thanks to the development of automatic firewall systems, system managers are no longer burdened with the responsibility of directly managing the security of their large-scale network systems. However, intrusion into network equipment that is not protected by an automatic firewall system may still occur throughout networks. This is commonly done by taking advantage of security vulnerabilities in web application programs installed in network equipment for adjusting settings, etc., such as routers, switches, printers and servers connected to the network by their own IP addresses.

To prevent such intrusions, the system manager may use a device to inspect network equipment for vulnerabilities, identify network equipment which may not be protected by the automatic firewall system, and tighten security on such equipment.

FIG. 1 is a diagram illustrating an operation environment of a conventional device for inspecting network equipment for vulnerabilities.

Referring to FIG. 1, a device 110 for inspecting network equipment for vulnerabilities operated by a system manager inspects network equipment 131, 132 and 133 through a public network 120 using IP addresses of the equipment. Accordingly, the conventional device for inspecting network equipment for vulnerabilities has the disadvantages of having to find out every IP address of the network equipment constituting the system and repeat inspection on each piece of network equipment.

### SUMMARY OF THE INVENTION

The present invention is directed to a device and method for inspecting network equipment for vulnerabilities that can perform security inspections on network equipment constituting a system more effectively.

One aspect of the present invention provides a device for inspecting network equipment for vulnerabilities, including: a network structure examination module for examining the structure of a system network and generating network structure information; a control module for selecting at least one subnet for vulnerability inspection according to the network structure information; a vulnerable network equipment examination module for examining at least one piece of target network equipment for vulnerability inspection in the at least one selected subnet using a search engine; a vulnerability inspection module for inspecting the target network equipment for vulnerabilities; and an inspection result display module for outputting inspection results received from the vulnerability inspection module.

Another aspect of the present invention provides a method for inspecting network equipment for vulnerabilities, including the steps of: (a) generating network structure information of the system network; (b) selecting at least one subnet for inspection according to the network structure information; (c) searching for at least one piece of target network equipment for vulnerability inspection in the at least one selected subnet using a search engine; (d) inspecting the at least one piece of target network equipment for vulnerabilities; and (e) outputting inspection results for the at least one piece of target network equipment.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings, in which:

FIG. 1 is a diagram illustrating an operation environment of a conventional device for inspecting network equipment for vulnerabilities;

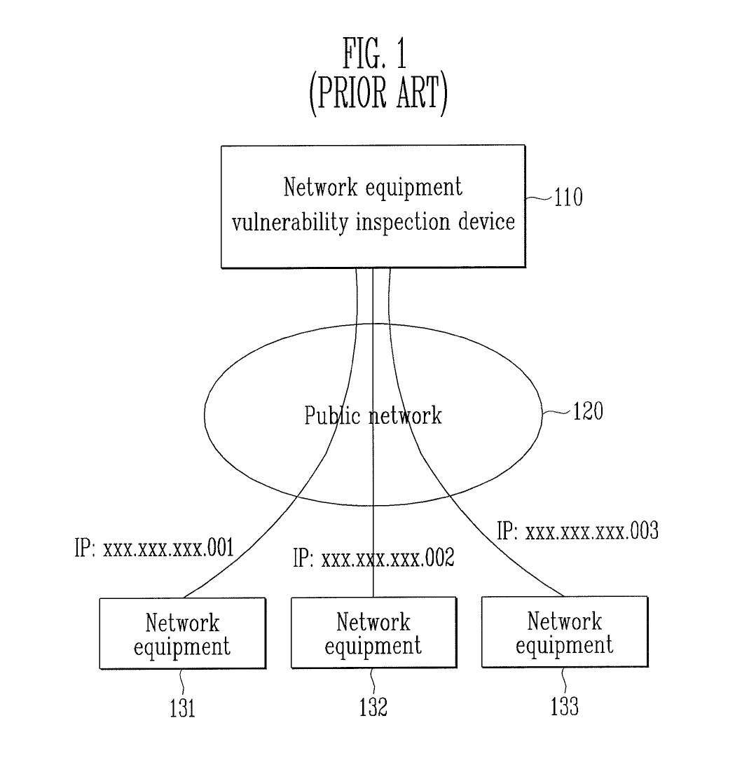

FIG. 2 is a diagram illustrating a configuration of a network equipment vulnerability inspection device according to an exemplary embodiment of the present invention; and

FIG. 3 is a flowchart illustrating a method for inspecting network equipment for vulnerabilities according to an exemplary embodiment of the present invention.

### DETAILED DESCRIPTION OF EXEMPLARY EMBODIMENTS

The foregoing and other objects, features and advantages of the invention will be apparent from the following more particular description of exemplary embodiments of the invention, as illustrated in the accompanying drawings.

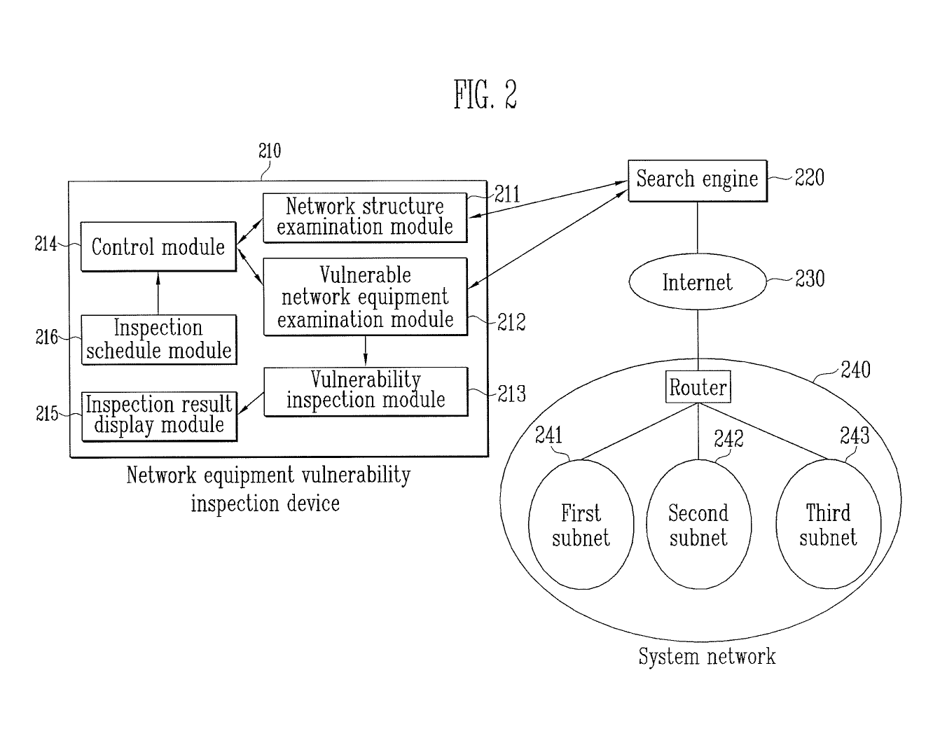

FIG. 2 is a diagram illustrating a configuration of a network equipment vulnerability inspection device according to an exemplary embodiment of the present invention.

Referring to FIG. 2, a network equipment vulnerability inspection device 210 includes a network structure examination module 211, a vulnerable network equipment examination module 212, a vulnerability inspection module 213, a control module 214, an inspection result display module 215 and an inspection schedule module 216.

The network structure examination module 211 generates network structure information on a system network 240 using a command such as WHOIS through a search engine 220, and transmits the information to the control module 214. In one exemplary embodiment, the network structure information may include information on IP addresses of the network equipment, information on a hierarchy of the network equipment, information on the existence of a demilitarized zone (DMZ), and information on connecting positions of network address translation (NAT) and a personal computer (PC). In one exemplary embodiment, the search engine 220 may be a common search engine on the Internet 230 or a separate search engine installed in the system.

The control module 214 selects subnet 241, 242 or 243, for vulnerability inspection according to network structure information received from the network structure examination module 211. Here, the subnet denotes a logically or physically separate network which is a part of a large-scale network. In the present embodiment, the control module 214 may select at least one of the subnets 241, 242 and 243 for vulnerability inspection using log information on system intrusions.

The vulnerable network equipment examination module 212 searches for target network equipment which may have vulnerabilities in the subnet 241, 242 or 243 selected by the control module 214 through the search engine 220, generate a target address list including a URL or IP address of the corresponding network equipment, and transmit the list to the vulnerability inspection module 213. In one exemplary embodiment, when the control module 214 selects the first subnet 241, the vulnerable network equipment examination module 212 may set a search range option for the search engine 220 to limit the search range to the first subnet 241, thereby allowing the search engine 220 to search only the first subnet 241. Moreover, the vulnerable network equipment examination module 212 may request a search for files affecting the security of the network among files stored in the network equipment to the search engine 220, and acquire an address of the target network equipment according to the search results.

The vulnerability inspection module 213 inspects target network equipment for vulnerabilities according to the address of the target network equipment included in the target address list through a public network such as the Internet 230. In the present embodiment, the vulnerability inspection module 213 may inspect the target network equipment for vulnerabilities using a vulnerability inspection query, which may be stored in a separate inspection query table, to test the security of network equipment.

The inspection result display module 215 outputs inspection results for the respective target network equipment which are received from the vulnerability inspection module 213. In one exemplary embodiment, the inspection result display module 215 may record the inspection results in a vulnerability inspection log stored in the system or display the results as a graph to a user through a graphic user interface (GUI).

The inspection schedule module 216 sets times for vulnerability inspection. In the present embodiment, the inspection schedule module 216 may schedule inspections at a period preset by the user or by request when a system intrusion is detected. Further, the inspection schedule module 216 may allow the vulnerability inspection to be performed at the preset time by ordering the start of inspection via the control module 214.

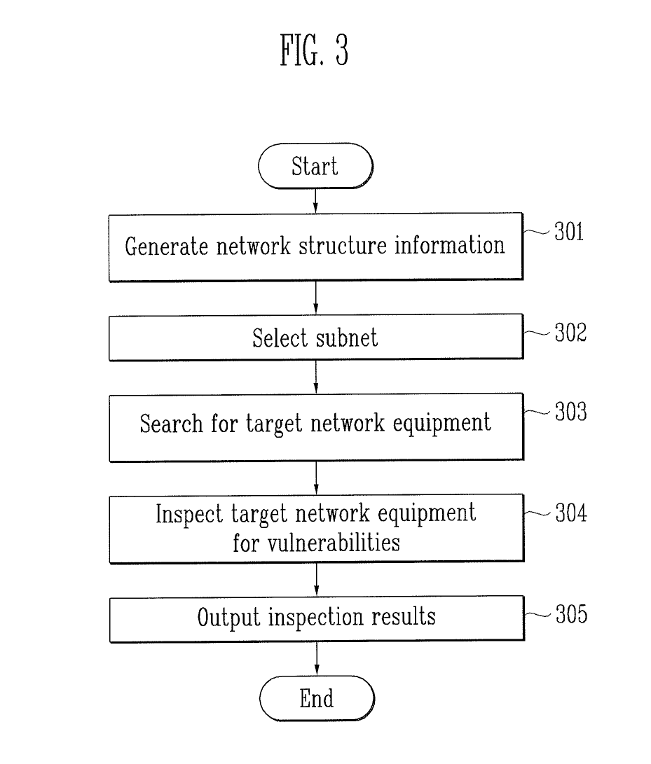

FIG. 3 is a flowchart illustrating a method of inspecting network equipment for vulnerabilities according to an exemplary embodiment of the present invention.

Referring to FIG. 3, a network structure examination module generates network structure information of a system network using a search engine (S301). In the present embodiment, the network structure examination module may use a command such as WHOIS to generate network structure information.

A control module selects a subnet for performing vulnerability inspection according to network structure information (S302). The control module may select a subnet, which has a high probability of intrusion through a network according to a certain standard with reference to, for example, log information on system intrusions. In one exemplary embodiment, the control module may change the standard for selecting a subnet according to the user's setting, and the subnet selected by the control module may include all or a part of the system network.

A vulnerable network equipment examination module searches for the inspection target network equipment in the subnet selected by the search engine, and generates a list of addresses for inspection, including addresses of any target network equipment (S303). To search for the inspection target network equipment, the vulnerable network equipment examination module searches for a specific file included in the network equipment using the search engine. For example, when the search engine finds an asp file or a .php file used to set up operation of the network equipment, it means that the operation setting of the network equipment can be changed by network intrusion. Thus, the vulnerable network equipment examination module may acquire the address of the corresponding network equipment through the search engine and add the address to the inspection target address list. In one exemplary embodiment, the vulnerable network equipment examination module may set a search range option for the search engine to examine the selected subnet only.

A vulnerability inspection module receives the target address list and inspects target network equipment whose addresses are included in the target address list for vulnerabilities (S304). In the present embodiment, the vulnerability inspection module may receive a response message to a vulnerability inspection query from the target network equipment to determine whether the security of network equipment has become vulnerable.

An inspection result display module outputs inspection results of the respective target network equipment received from the vulnerability inspection module (S305). Each inspection result may be written in a log in the system or output as text or a graph according to a user's request.

The present invention may reduce vulnerability inspection time and overhead of a system subject to inspection by targeting a subnet for inspection among subnets constituting the system according to network structure information, examining potentially vulnerable network equipment in the selected subnet using a search engine, and inspecting the network equipment for vulnerabilities.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A device for inspecting network equipment for vulnerabilities, comprising:
a network structure examination module for examining the structure of a system network and generating network structure information;
a control module for selecting at least one subnet for vulnerability inspection according to the network structure information;
a vulnerable network equipment examination module for examining at least one piece of target network equipment for vulnerability inspection in the at least one selected subnet using a search engine;
a vulnerability inspection module for inspecting the target network equipment for vulnerabilities; and
an inspection result display module for outputting inspection results received from the vulnerability inspection module.

2. The device according to claim 1, further comprising:
an inspection schedule module for setting up times for performing vulnerability inspections.

3. The device according to claim 1, wherein the network structure examination module examines the structure of the system network using the search engine.

4. The device according to claim 1, wherein the network structure information comprises at least one of information on IP addresses of the network equipment, information on a hierarchy of the network equipment, information on the existence of a demilitarized zone (DMZ), and information on connecting positions of network address translation (NAT) and a personal computer (PC).

5. The device according to claim 1, wherein the search engine is commonly-used on the Internet or installed in the system.

6. The device according to claim 1, wherein the vulnerability network equipment examination module generates a target address list including an address of the target network equipment, and the vulnerability inspection module inspects the network equipment for vulnerability according to the target address list.

7. The device according to claim 1, wherein the vulnerable network equipment examination module limits a search range option of the search engine to the target subnet, and examines the target network equipment.

8. The device according to claim 1, wherein the vulnerability inspection module receives a response message to a vulnerability inspection query from the target network equipment, and performs vulnerability inspection according to the response message.

9. A method for inspecting network equipment for vulnerabilities included in a system network, comprising the steps of:
(a) generating network structure information of the system network;
(b) selecting at least one subnet for inspection according to the network structure information;
(c) searching for at least one piece of target network equipment for vulnerability inspection in the at least one selected subnet using a search engine;
(d) inspecting the at least one piece of target network equipment for vulnerabilities; and
(e) outputting inspection results for the at least one piece of target network equipment.

10. The method according to claim 9, wherein, in step (a), the network structure information is generated using the search engine.

11. The method according to claim 9, wherein the network structure information comprises at least one of information on IP addresses of the network equipment, information on a hierarchy of the network equipment, information on the existence of a demilitarized zone (DMZ), and information on connecting positions of network address translation (NAT) and a personal computer (PC).

12. The method according to claim 9, wherein the search engine is common-used on the Internet or installed in the system.

13. The method according to claim 9, wherein step (d) comprises the steps of:
(d1) transmitting a vulnerability inspection query to the at least one piece of target network equipment;
(d2) receiving a response message to the query from the at least one piece of target network equipment; and
(d3) determining whether or not the at least one piece of target network equipment has security vulnerabilities according to the response message.
